(19) United States
(12) Patent Application Publication
(10) Pub. No.: US 2022/0396715 A1
(43) Pub. Date: Dec. 15, 2022

(54) GRINDING OF HARD SUBSTRATES

(71) Applicant: ENTEGRIS, INC., Billerica, MA (US)

(72) Inventors: Rajiv K. Singh, Newberry, FL (US); Sunny De, Gainesville, FL (US)

(21) Appl. No.: 17/840,448

(22) Filed: Jun. 14, 2022

Related U.S. Application Data
(60) Provisional application No. 63/210,357, filed on Jun. 14, 2021.

(51) Int. Cl. C09G 1/02; B24B 37/04

(52) U.S. Cl. CPC C09G 1/02; B24B 37/044

(57) ABSTRACT

The invention provides improved slurries for the polishing of hard materials such as those having a Mohs hardness of greater than about 6. Exemplary hard surfaces include sapphire, silicon carbide, silicon nitride, and gallium nitride, and diamond. In the compositions and method of the invention, novel compositions comprising a unique combination of additives which surprisingly were found to uniformly disperse diamond particles having a wide range of particle size in a slurry. In the method of the invention, the generally alkaline slurry compositions of the invention are capable of utilizing diamond particle sizes of greater than 40 microns while effecting good removal rates. In such cases, when utilized with a suitable pad, rapid and planar grinding of silicon carbide, silicon nitride, sapphire, gallium nitride, and diamond is possible, with uniform surface damage.

### TECHNICAL FIELD

The present invention generally relates to improved compositions and methods for the grinding and polishing of hard substrate surfaces.

### BACKGROUND

Chemical Mechanical Polishing or Chemical Mechanical Planarization (CMP) is a common method to planarize substrates. CMP utilizes a slurry generally including water, a chemical additive and particles for selective removal of material from substrates. In conventional CMP, a substrate carrier or polishing head is mounted on a carrier assembly and positioned in contact with a polishing pad in a CMP apparatus. The carrier assembly provides a controllable pressure to the substrate pressing the substrate against the polishing pad. The pad is moved relative to the substrate.

In the case of hard substrates, such as sapphire, silicon carbide, gallium nitride, and diamond, hard slurry particles such as diamond, cubic boron nitride, silicon carbide, and boron carbide are routinely applied to polish such substrates using a mechanical polishing process such as lapping and grinding. The size of the particles typically controls the removal rate, where the larger the particle size generally provides the higher rates. However, larger particles also cause higher surface and sub-surface damage, so that mechanical polishing/grinding processes may employ multiple steps. For example, initially larger sized particles can be used in earlier step(s) followed by smaller and smaller size particles in later step(s) in an attempt to improve the removal rate and the surface finish. Typically, such large hard particles are not used in CMP processes as they can induce a high degree of damage during the polishing processes. By way of example, a planarized hard surface material is prepared by sawing or cutting a generally circular piece of a given hard surface. The substrate is then typically subjected to grinding using slurry compositions containing diamond or boron nitride particles of approximately 100 microns in diameter. These slurry compositions are generally fed onto a metal plate, such as cast iron, steel, copper, tin, etc., while the plate exerts pressure on the hard substrate. The next step, involving lapping (i.e., stock removal) then generally involves the use of particles of around 10 microns in diameter. The final polishing of the hard substrate is then undertaken with a polishing slurry utilizing particles around 1 micron in diameter.

Using these conventional slurries, the varying size distribution of diamond particles and especially the presence of large diamond particles can lead to deep surface scratches and damage in the substrate material. Moreover, the larger diamond particles tend to settle down easily (i.e., do not remain dispersed), and are thus difficult to recirculate into the polishing process.

Accordingly, there continues to be a need for the development of improved grinding/polishing slurries for hard surface materials such as sapphire, silicon carbide, gallium nitride, and diamond.

### SUMMARY

In summary, the invention provides improved slurries for the grinding of hard materials such as those having a Mohs hardness of greater than about 6. Exemplary hard surfaces include sapphire, silicon carbide, silicon nitride, and gallium nitride, and diamond. In the compositions and method of the invention, novel compositions comprising a unique combination of additives were surprisingly found to uniformly disperse diamond particles having a wide range of particle size in a slurry. This quality aids in the recycling of slurry compositions given this high level of dispersion and concomitant slurry uniformity. In the method of the invention, the generally alkaline slurry compositions of the invention are capable of utilizing diamond particle sizes of greater than 40 microns while effecting good removal rates. In such cases, when utilized with a suitable pad, rapid and planar grinding of silicon carbide, silicon nitride, sapphire, gallium nitride, and diamond is possible, with uniform surface damage. Additionally, unlike conventional slurries and methodologies, the compositions and method of the invention are capable of using larger diamond particles without resulting in deep scratches in the substrate materials.

### BRIEF DESCRIPTION OF THE DRAWINGS

FIG. 1 is 20× image obtained using an Optical Profilometer, using a composition of the invention comprising a 40 μm diamond particle.

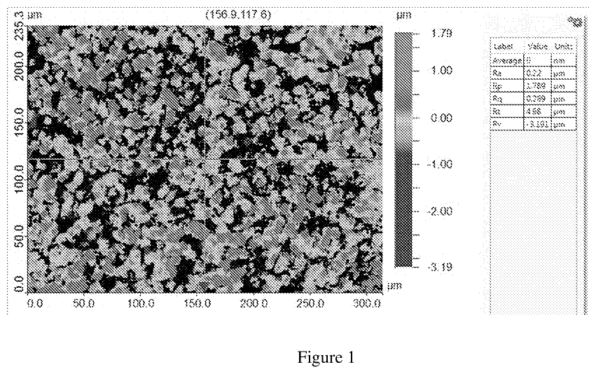

FIG. 2 is a 20× image obtained using an Optical Profilometer, using a composition of the invention comprising a 60 μm diamond particle.

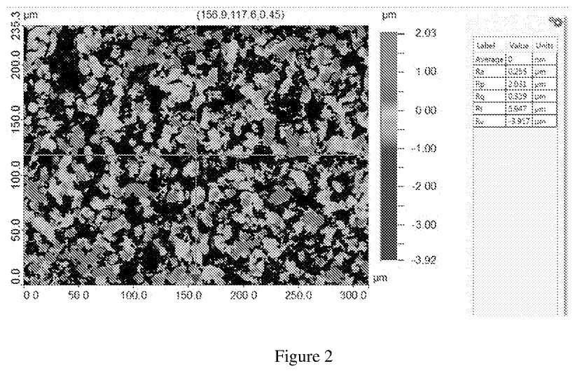

FIG. 3 is a 20× image obtained using an Optical Profilometer, using a composition of the invention comprising an 80 μm diamond particle.

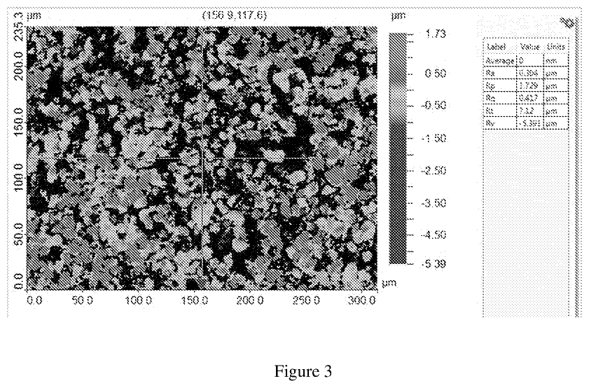

FIG. 4 is a 20× image obtained using an Optical Profilometer, using a conventional grinding slurry comprising a 40 μm diamond particle (i.e., comparative).

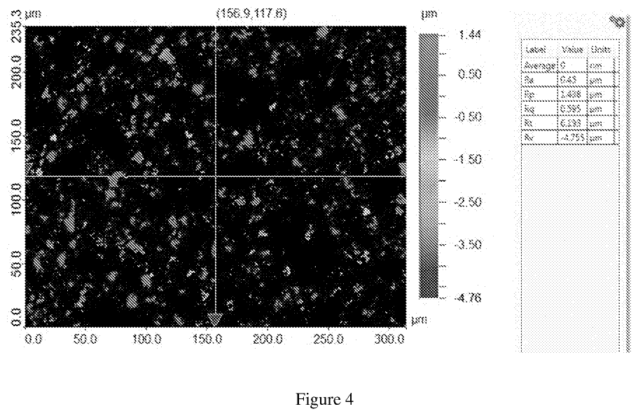

FIG. 5 is a plot of material removal rate (μm/hour) versus applied pressure (psi) for a composition of the invention utilizing diamond particles of about 80 microns.

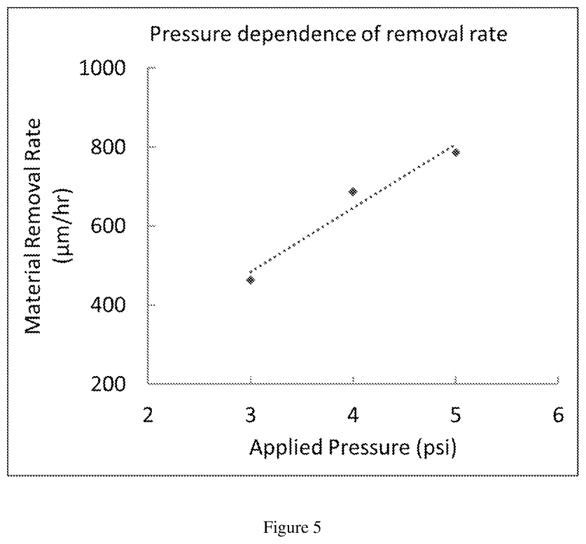

FIG. 6 is a plot of material removal rate (μm/hour) versus polishing duration (hours) for a composition of the invention.

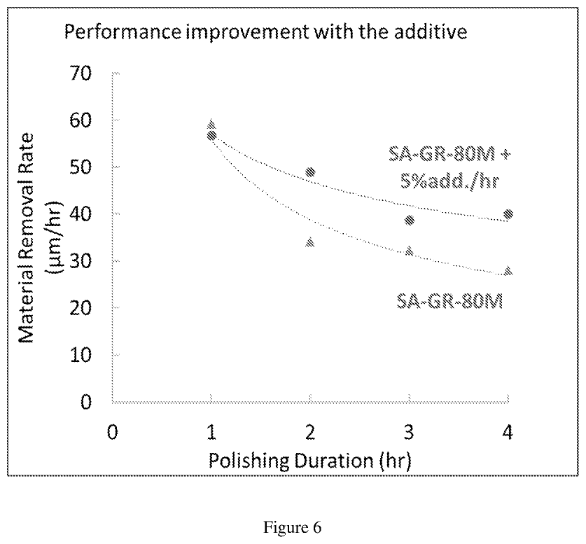

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

In a first aspect, the invention provides a composition comprising:

water,

diamond particles having an average diameter of from about 40 μm to about 120 μm, and

a dispersant, wherein said dispersant is comprised of at least one weak base and at least one water-miscible solvent,

wherein the composition has a pH of greater than about 6.

In the compositions of the invention, the diamond particles are in certain embodiments about 50 μm to about 110 μm, about 60 μm to about 100 μm, about 70 μm to about 90 μm, about 50 μm to about 70 μm, about 60 μm to about 80 μm, or about 70 μm to about 90 μm in average diameter. The diamond particles may be spherical or non-spherical. Exemplary non-spherical shapes include a polygonal column shape such as a triangular column or a square column, a cylindrical shape, a bale shape in which the central part of the cylinder is more inflated than the end part, a donut shape in which the center part of a disk is penetrated, a plate shape, a so-called cocoon shape having constriction in the center part, a so-called assembly-typed spherical shape in which a plurality particles are integrated, a so-called konpeito-typed shape having a plurality of projections on the surface, a rugby ball shape, and the like, but not particularly limited thereto. In one embodiment, the diamond particles are generally spherical in shape. In one embodiment, the diamond particles have an aspect ratio of about −1 to about 10. In general, the diamond particles will advantageously have a narrow size distribution about the target diameter. In one embodiment, the amount of diamond particles is about 0.001 to about 20 weight percent, based on the total weight of the composition. In another embodiment, the amount is about 1.5 weight percent. Suitable diamond particles may be obtained commercially as single crystal abrasives, generally in powder form.

The dispersant utilized in the present invention is a combination of a weak organic base and a water miscible solvent.

Exemplary weak bases include weak organic bases such as C2-C8 alkanolamines and weak inorganic bases such as aqueous ammonia (NH₄OH). Exemplary weak bases include ammonium hydroxide, monoethanolamine (MEA), diethanolamine (DEA), triethanolamine (TEA), ethylenediamine, cysteine, N-methylethanolamine, N-methyldiethanolamine, dimethylethanolamine, N, N-diisopropylaminoethanol, methyl diethanolamine, bis-tris methane, meglumine (an amino sugar), aminoethylethanolamien, N-methylaminoethanol, aminoethoxyethanol, dimethylaminoethoxyethanol, isopropanolamine, diisopropanolamine, aminopropyldiethanolamine, N,N-dimethylpropanolamine, N-methylpropanolamine, 1-amino-2-propanol, 2-amino-1-butanol, isobutanolamine, and the like, and combinations thereof.

In certain embodiments, the water-miscible solvents are glycol ethers. Exemplary glycol ethers include: diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol monomethyl ether, dipropylene glycol methyl ether (DPGME), tripropylene glycol methyl ether (TPGME), dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and mixtures thereof.

In other embodiments the water-miscible organic solvents are glycols and polyols (compounds having 3 or more hydroxyl moieties).

As noted above, the compositions of the invention have a pH of greater than or equal about 8. In certain embodiments, the pH is about 8 to about 9, about 8 to about 10, about 9 to about 10, or about 6 to about 13.5.

If necessary, a pH adjustor may be utilized. Suitable pH adjustors include organic bases and inorganic bases. Examples of suitable bases include for this purpose include: choline hydroxide, tetrabutylphosphonium hydroxide (TBPH), tetramethylphosphonium hydroxide, tetraethylphosphonium hydroxide, tetrapropylphosphonium hydroxide, benzyltriphenylphosphonium hydroxide, methyl triphenylphosphonium hydroxide, ethyl triphenylphosphonium hydroxide, N-propyl triphenylphosphonium hydroxide, tetraethylammonium hydroxide (TEAH), tetrapropylammonium hydroxide (TPAH), tetrabutylammonium hydroxide (TBAH), trimethylethylammonium hydroxide, diethyldimethylammonium hydroxide, tributylmethylammonium hydroxide (TBMAH), benzyltrimethylammonium hydroxide (BTMAH), tetramethylammonium hydrochloride (TMAH), tris(2-hydroxyethyl)methyl ammonium hydroxide, diethyldimethylammonium hydroxide, arginine, potassium hydroxide, cesium hydroxide and combinations thereof. In one embodiment, the pH adjustor is TMAH (tetramethyl ammonium hydroxide).

Unlike other grinding regimes for hard surfaces, which often use hard metallic grinding plates, the composition of the present invention utilizes a grinding pad which has suitable elasticity to accommodate the larger diamond particles of the composition so as to not exert undue force on the substrate surface, thereby avoiding undesirable deep scratches. In this regard, the grinding pad may be comprised of, for example, any type of polymer-based polishing pad. Alternately, the pad may be comprised of other suitable materials such as suede. Examples of polishing pads are based on polyurethane pads and suede pads. The pad thickness can in certain embodiments vary from about 0.1 mm to about 25 mm. The hardness of the pads can vary from Asker C hardness of 5 to Asker Hardness of 95. The compressibility of the pad can be from 0.1% to 40%. The pads are generally non-porous. In certain embodiments, the pore size of the pads can vary from about 0 to about 20 microns, or about 0 to about 10 microns.

Examples of polyurethane-based pads are well known in the art and can be found commercially. The hardness of these pads ranges from Shore D value of 5 to 99. Generally any other type of polymeric material can be used with the slurry.

Suitable apparatuses for chemical mechanical polishing are commercially available. The method of the invention generally involves mixing the slurry composition comprising the components set forth above, placing the hard substrate to be polished into a CMP apparatus having a rotating pad, and then performing chemical mechanical polishing using the slurry compositions of the invention. In this method of polishing, at least some of the hard substrate surface will be removed or abraded, thereby providing a suitably polished hard substrate.

Accordingly, in a second aspect, the invention provides a method for polishing a surface chosen from diamond, sapphire, silicon carbide, and gallium nitride, the method comprising:
contacting the substrate with the composition of the invention as set forth in the first aspect;
moving the composition relative to the substrate, and
   a. abrading the substrate to remove a portion of the surface, thereby providing a polished surface.

### EXAMPLES

Experimental Setup:

All the below removal rate experiments were performed on Buehler Automet 250 tabletop polisher, with a 100 mm C-plane sapphire, with Platen speed of 150 rpm. Flow rate of 30 mL/min was maintained. Data was generated on a polishing hard non-porous polyurethane polishing pad with Shore D hardness of 70, The diamond particles were utilized at 1.5 weight percent, based on the weight of the composition.

TABLE 1
Removal rate vs pH of grinding slurry (keeping
additives composition constant)

| Diamond Size | | | Removal Rate |
|---|---|---|---|
| Used (micron)* | Additives Used | pH | (micron/min) |
| 80 | Propylene Glycol Monomethyl | 10.50 | 20.2 |
| | Ether + Dimethylethanolamine | | |
| 80 | Propylene Glycol Monomethyl | 8.50 | 18.7 |
| | Ether + Dimethylethanolamine | | |
| 80 | Propylene Glycol Monomethyl | 11.50 | 20.3 |
| | Ether + Dimethylethanolamine | | |
| 80 | Propylene Glycol Monomethyl | 12.50 | 21.6 |
| | Ether + Dimethylethanolamine | | |
| 80 | Propylene Glycol Monomethyl | 13.50 | 19.8 |
| | Ether + Dimethylethanolamine | | |
| 80 | Propylene Glycol Monomethyl | 6.50 | 17.9 |
| | Ether + Dimethylethanolamine | | |
| 80 | Propylene Glycol Monomethyl | 7.50 | 19.3 |
| | Ether + Dimethylethanolamine | | |

TABLE 2
Removal rate vs diamond size (D50) of grinding
slurry (keeping additives composition constant)

| Diamond Size | | | Removal Rate |
|---|---|---|---|
| Used (micron) | Additives Used | pH | (micron/min) |
| 80 | Propylene Glycol Monomethyl | 10.50 | 20.2 |
| | Ether + Dimethylethanolamine | | |
| 10 | Propylene Glycol Monomethyl | 10.50 | 0.46 |
| | Ether + Dimethylethanolamine | | |
| 20 | Propylene Glycol Monomethyl | 10.50 | 1.2 |
| | Ether + Dimethylethanolamine | | |
| 40 | Propylene Glycol Monomethyl | 10.50 | 3.67 |
| | Ether + Dimethylethanolamine | | |
| 60 | Propylene Glycol Monomethyl | 10.50 | 7.3 |
| | Ether + Dimethylethanolamine | | |
| 100 | Propylene Glycol Monomethyl | 10.50 | 22.6 |
| | Ether + Dimethylethanolamine | | |
| 120 | Propylene Glycol Monomethyl | 10.50 | 21.9 |
| | Ether + Dimethylethanolamine | | |

TABLE 3
Removal rate vs Varying Additive Composition of
grinding slurry (keeping diamond size constant)

| Diamond Size | | | Removal Rate |
|---|---|---|---|
| Used (micron) | Additives Composition | pH | (micron/min) |
| 80 | 2 wt % Propylene Glycol | 10.50 | 20.2 |
| | Monomethyl Ether + 0.6 | | |
| | wt % Dimethylethanolamine | | |
| 80 | 1 wt % Propylene Glycol | 10.50 | 17.9 |
| | Monomethyl Ether + 0.3 | | |
| | wt % Dimethylethanolamine | | |
| 80 | 0.5 wt % Propylene Glycol | 10.50 | 15.8 |
| | Monomethyl Ether + 0.15 | | |
| | wt % Dimethylethanolamine | | |
| 80 | 0.1 wt % Propylene Glycol | 10.50 | 12.9 |
| | Monomethyl Ether + 0.03 | | |
| | wt % Dimethylethanolamine | | |
| 80 | 0.01 wt % Propylene Glycol | 10.50 | 7.4 |
| | Monomethyl Ether + 0.003 | | |
| | wt % Dimethylethanolamine | | |
| 80 | 3 wt % Propylene Glycol | 10.50 | 20.6 |
| | Monomethyl Ether + 0.9 | | |
| | wt % Dimethylethanolamine | | |
| 80 | 5 wt % Propylene Glycol | 10.50 | 20.4 |
| | Monomethyl Ether + 1.5 | | |
| | wt % Dimethylethanolamine | | |

### ASPECTS

In a first aspect, the invention provides a composition comprising:
water,
diamond particles having an average diameter of from about 40 μm to about 120 μm, and
a dispersant, wherein said dispersant is comprised of at least one weak base and at least one water-miscible solvent,

wherein the composition has a pH of greater than about 6.

In a second aspect, the invention provides the composition of the first aspect, wherein the diamond particles have an average diameter of about 50 μm to about 110 μm.

In a third aspect, the invention provides the composition of the first aspect, wherein the diamond particles have an average diameter of about 60 μm to about 100 μm.

In a fourth aspect, the invention provides the composition of the first aspect, wherein the diamond particles have an average diameter of about 70 μm to about 90 μm.

In a fifth aspect, the invention provides the composition of the first aspect, wherein the diamond particles have an average diameter of about 50 μm to about 70 μm.

In a sixth aspect, the invention provides the composition of the first aspect, wherein the diamond particles have an average diameter of about 60 μm to about 80 μm.

In a seventh aspect, the invention provides the composition of the first aspect, wherein the diamond particles have an average diameter of about 70 μm to about 90 μm.

In an eighth aspect, the invention provides the composition of any one of the first through the seventh aspects, wherein the weak base is chosen from aqueous ammonia, monoethanolamine, diethanolamine, triethanolamine, ethylenediamine, cysteine, N-methylethanolamine, N-methyldiethanolamine, dimethylethanolamine, N, N-diisopropylaminoethanol, methyl diethanolamine, bis-tris methane, meglumine, aminoethylethanolamine, N-methylaminoethanol, aminoethoxyethanol, dimethylaminoethoxyethanol, isopropanolamine, diisopropanolamine, aminopropyldiethanolamine, N,N-dimethylpropanolamine, N-methylpropanolamine, 1-amino-2-propanol, 2-amino-1-butanol, isobutanolamine, and combinations thereof.

In a ninth aspect, the invention provides the composition of any one of the first through the eighth aspects, wherein the weak base is dimethylethanolamine.

In a tenth aspect, the invention provides the composition of any one of the first through ninth aspects, wherein the amount of diamond particles in the composition is about 0.001 to about 20 weight percent, based on the total weight of the composition.

In an eleventh aspect, the invention provides the composition of any one of the first through the tenth aspects, wherein the composition has a pH of about 6 to about 13.5.

In a twelfth aspect, the invention provides a method for polishing a hard surface, the method comprising:
contacting the substrate with the composition of the claim 1; and
abrading the substrate to remove a portion of the surface, thereby providing a polished surface.

In a thirteenth aspect, the invention provides the method of the twelfth aspect, wherein the diamond particles have an average diameter of about 50 μm to about 110 μm.

In a fourteenth aspect, the invention provides the method of the twelfth aspect, wherein the diamond particles have an average diameter of about 60 μm to about 100 μm.

In a fifteenth aspect, the invention provides the method of the twelfth aspect, wherein the diamond particles have an average diameter of about 70 μm to about 90 μm.

In a sixteenth aspect, the invention provides the method of the twelfth aspect, wherein the diamond particles have an average diameter of about 50 μm to about 70 μm.

In a seventeenth aspect, the invention provides the method of the twelfth aspect, wherein the diamond particles have an average diameter of about 60 μm to about 80 μm.

In an eighteenth aspect, the invention provides the method of the twelfth aspect, wherein the diamond particles have an average diameter of about 70 μm to about 90 μm.

In a nineteenth aspect, the invention provides the method of any one of the twelfth through eighteenth aspects, wherein the weak base is chosen from aqueous ammonia, monoethanolamine, diethanolamine, triethanolamine, ethylenediamine, cysteine, N-methylethanolamine, N-methyldiethanolamine, dimethylethanolamine, N, N-diisopropylaminoethanol, methyl diethanolamine, bis-tris methane, meglumine, aminoethylethanolamine, N-methylaminoethanol, aminoethoxyethanol, dimethylaminoethoxyethanol, isopropanolamine, diisopropanolamine, aminopropyldiethanolamine, N,N-dimethylpropanolamine, N-methylpropanolamine, 1-amino-2-propanol, 2-amino-1-butanol, isobutanolamine, and combinations thereof.

In a twentieth aspect, the invention provides the method of any one of the twelfth through the nineteenth aspects, wherein the weak base is dimethylethanolamine.

In a twenty-first aspect, the invention provides the method of any one of the twelfth through the twentieth aspects, wherein the amount of diamond particles in the composition is about 0.001 to about 20 weight percent, based on the total weight of the composition.

In a twenty-second aspect, the invention provides the method of any one of the twelfth through the twenty-first aspects, wherein the composition has a pH of about 6 to about 13.5.

In a twenty-third aspect, the invention provides the method of any one of the twelfth through the twenty-second aspects, wherein the hard surface is chosen from sapphire, silicon carbide, gallium nitride, and diamond.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A composition comprising:
water,
diamond particles having an average diameter of from about 40 μm to about 120 μm, and
a dispersant, wherein said dispersant is comprised of at least one weak base and at least one water-miscible solvent,
wherein the composition has a pH of greater than about 6.

2. The composition of claim 1, wherein the diamond particles have an average diameter of about 50 μm to about 110 μm.

3. The composition of claim 1, wherein the diamond particles have an average diameter of about 60 μm to about 100 μm.

4. The composition of claim 1, wherein the diamond particles have an average diameter of about 70 μm to about 90 μm.

5. The composition of claim 1, wherein the diamond particles have an average diameter of about 50 μm to about 70 μm.

6. The composition of claim 1, wherein the diamond particles have an average diameter of about 60 μm to about 80 μm.

7. The composition of claim 1, wherein the diamond particles have an average diameter of about 70 μm to about 90 μm.

8. The composition of claim 1, wherein the weak base is chosen from aqueous ammonia, monoethanolamine, diethanolamine, triethanolamine, ethylenediamine, cysteine, N-methylethanolamine, N-methyldiethanolamine, dimethylethanolamine, N, N-diisopropylaminoethanol, methyl diethanolamine, bis-tris methane, meglumine, aminoethylethanolamine, N-methylaminoethanol, aminoethoxyethanol, dimethylaminoethoxyethanol, isopropanolamine, diisopropanolamine, aminopropyldiethanolamine, N,N-dimethylpropanolamine, N-methylpropanolamine, 1-amino-2-propanol, 2-amino-1-butanol, isobutanolamine, and combinations thereof.

9. The composition of claim 1, wherein the weak base is dimethylethanolamine.

10. The composition of claim 1, wherein the amount of diamond particles in the composition is about 0.001 to about 20 weight percent, based on the total weight of the composition.

11. The composition of claim 1, wherein the composition has a pH of about 6 to about 13.5.

12. A method for polishing a hard surface, the method comprising:
contacting the substrate with the composition comprising:
water; diamond particles having an average diameter of from about 40 μm to about 120 μm; and a dispersant, wherein said dispersant is comprised of at least one weak base and at least one water-miscible solvent;
abrading the substrate to remove a portion of the surface, thereby providing a polished surface.

13. The method of claim 12, wherein the diamond particles have an average diameter of about 50 μm to about 110 μm.

14. The method of claim 12, wherein the diamond particles have an average diameter of about 60 μm to about 100 μm.

15. The method of claim 12, wherein the diamond particles have an average diameter of about 70 μm to about 90 μm.

16. The method of claim 12, wherein the diamond particles have an average diameter of about 50 μm to about 70 μm.

17. The method of claim 12, wherein the diamond particles have an average diameter of about 60 μm to about 80 μm.

18. The method of claim 12, wherein the diamond particles have an average diameter of about 70 μm to about 90 μm.

19. The method of claim 12, wherein the weak base is chosen from aqueous ammonia, monoethanolamine, diethanolamine, triethanolamine, ethylenediamine, cysteine, N-methylethanolamine, N-methyldiethanolamine, dimethylethanolamine, N, N-diisopropylaminoethanol, methyl diethanolamine, bis-tris methane, meglumine, aminoethylethanolamine, N-methylaminoethanol, aminoethoxyethanol, dimethylaminoethoxyethanol, isopropanolamine, diisopropanolamine, aminopropyldiethanolamine, N,N-dimethylpropanolamine, N-methylpropanolamine, 1-amino-2-propanol, 2-amino-1-butanol, isobutanolamine, and combinations thereof.

20. The method of claim 12, wherein the weak base is dimethylethanolamine.
